(19) United States
(12) Patent Application Publication
(10) Pub. No.: US 2019/0376551 A1
(43) Pub. Date: Dec. 12, 2019

(54) STATIONARY THRUST BEARING OF A STATIONARY AND ROTATING THRUST BEARING SYSTEM INTENDED FOR WITHSTANDING AN AXIAL LOAD

(71) Applicant: RENAULT s.a.s., Boulogne-Billancourt (FR)

(72) Inventor: Vincent LUERE, Velizy-Villacoublay (FR)

(73) Assignee: RENAULT s.a.s., Boulogne-Billancourt (FR)

(21) Appl. No.: 16/476,194

(22) PCT Filed: Dec. 21, 2017
(86) PCT No.: PCT/FR2017/053777

§ 371 Date: Aug. 12, 2019

(30) Foreign Application Priority Data
Jan. 10, 2017 (FR) 1750196

(51) Int. Cl. F16C 17/04; F16C 33/10

(52) U.S. Cl. CPC F16C 17/047; F16C 2360/22; F16C 33/1075

(57) ABSTRACT

A stationary thrust bearing is for a stationary and rotating thrust bearing system designed to withstand an axial load along an axis of a rotation shaft mounted in a guide bearing, in particular of a turbocharger. The stationary thrust bearing includes a flange in which is created a through-opening that allows the rotation shaft to pass through and has, on a face, pads with structured regions. Specifically, at least two sets of the pads, which include a first set of pads with structured regions present in a first ring on the face of the flange, and a second set of pads with structured regions present in a second ring, coaxial with the first ring, on the face of the flange, set back relative to the first set of pads in the longitudinal direction of the axis of the opening.

The present invention relates to a stationary thrust bearing of a stationary and rotating thrust bearing system, in particular for a turbocharger and especially a motor vehicle.

The circuit for forced induction of oxidant of an internal combustion engine vehicle often comprises a turbocharger by means of which, by compressing the air, it is possible to send a greater quantity of oxidant—oxygen—into the cylinders of the combustion chamber where this oxidant mixes with the fuel. Conventionally, this turbocharger comprises a turbine wheel which is driven by the energy of the exhaust gases and which is mounted on the same rotation shaft as a compressor wheel for the intake air. The shaft is mounted in rotation in a guide bearing inside a casing, between the turbine wheel and the compressor wheel. Pressure variations in the turbocharger give rise to thrust and counterthrust on the shaft, creating an axial load which can cause the shaft, and in some cases its guide bearing, to move along its axis. In order to prevent any movement of the shaft, and in some cases its guide bearing, there is provided a thrust bearing system for the purpose of withstanding the axial load along the axis of the shaft.

A thrust bearing system comprising a rotating thrust bearing which rotates conjointly with the shaft, and a stationary thrust bearing which faces the rotating thrust bearing and through which passes the shaft of the turbocharger are known.

The stationary thrust bearing is conventionally formed of a flange, a generally circular plate, in which is created a central opening through which passes the shaft of the turbocharger, comprising a set of pads present on the face of the plate and in a ring following the circumference of this opening. A lubricant, provided by an external source, is for example introduced via an orifice formed in the casing housing the device, and is conveyed in particular toward the thrust bearings.

The surface of the pads is structured so as to create a lubricant film between this stationary thrust bearing and the rotating thrust bearing. The structured surface of the pads, by means of reliefs such as shoulders and/or grooves, defines the hydraulic support surface between the opposing faces of the stationary thrust bearing and of the rotating thrust bearing. In operation, these reliefs create micro-reservoirs that can receive the lubricant which spreads out as a film under the effect of the force generated by the rotation of the rotating thrust bearing. During rotation of the shaft conjointly driving the rotating thrust bearing, this lubricating film creates a force between the thrust bearings which tends to move the rotating thrust bearing away from the stationary thrust bearing, of the order of approximately twenty micrometers, which has the effect of facilitating sliding friction between the thrust bearings while avoiding mechanical friction between the surface of the pads and the surface of the opposing rotating thrust bearing.

For the engine to have high efficiency, the shaft of the turbocharger must be able to rotate at variable speeds and be able to rotate at very high speed. The performance of the turbocharger can be impaired by the existence of friction between the pads of the stationary thrust bearing and the rotating thrust bearing. It can therefore be desirable to reduce the hydraulic support surface (also referred to as the supporting surface) between the thrust bearings in order to reduce sliding friction. However, this reduction in supporting surface can lead to a reduction in the capacity of a thrust bearing to provide the presence of a continuous lubricant film which protects it from mechanical contact with the other thrust bearing, the consequence of which would be irreparable damage.

It is therefore necessary to be able to ensure the robustness of the system with regard to maintaining the lubricant film under all circumstances and in particular in the case of disruptive events such as the ingress of dirt into the lubricant or variation of the axial load. Indeed, for example the presence of a grain of dirt in the lubricant can score the surface of the pads of the stationary thrust bearing to the point that it becomes worn, and the thrust bearing can no longer carry out its role. Equally, an abrupt increase in the axial load can produce a large pressure on the thrust bearings, to the point of bringing them into mechanical contact.

The invention aims to solve the above-mentioned drawbacks and respond to the need for a more high-performance thrust bearing system.

To that end, the invention proposes a stationary thrust bearing of a stationary and rotating thrust bearing system designed to withstand an axial load along the axis of a rotation shaft mounted in a guide bearing, in particular of a turbocharger, said stationary thrust bearing being in the form of a flange in which is created a through-opening that allows the shaft to pass through, provided with pads present on the face of said flange, said stationary thrust bearing comprising at least two sets of pads: a first set of pads present on the face of said flange and a second set of pads present on said same face of the flange, and set back relative to said first set of pads in the longitudinal direction of the axis of said opening.

According to a preferred embodiment of the invention, the second set of pads is set back from said first set of pads by a distance of several micrometers in the longitudinal direction of the axis of said opening.

According to a preferred embodiment of the invention, the pads of the first set are arranged in a ring following the perimeter of the opening of the flange. Also preferably, according to the invention, the second set of pads is arranged following the larger circumference of the ring formed by the first set of pads.

The supporting surface, or hydraulic support surface, is defined by the structured regions of the pads, for a given set of pads.

According to one particular embodiment of the invention, the second set of pads has a hydraulic support surface, defined by the surface of the structured regions of its pads, which is essentially identical to that of the first set of pads.

According to another particular embodiment of the invention, the second set of pads has a hydraulic support surface, defined by the surface of the structured regions of its pads, which is strictly greater than that of the first set.

Owing to the fact that the second set of pads is arranged set back from the first set, this second set provides no hydraulic support in normal operation. Nonetheless, in the event of failure of the first set of pads, for example by wear, the second set of pads takes over so as to provide the hydraulic support. It thus provides the reliability and the robustness of the system with a supporting surface that is greater than or equal to the first according to the above-mentioned embodiments.

The invention also relates to a thrust bearing system to be mounted about a rotation shaft, in particular of a turbocharger mounted in a guide bearing, to withstand an axial load along the axis of the shaft, said system comprising a rotating thrust bearing mounted conjointly around said shaft, and a stationary thrust bearing which has pads with structured regions and through which said shaft can pass, said thrust bearings being arranged face-to-face in the longitudinal direction of their axis, corresponding to the axis of the shaft, and such that the structured regions of said pads of the stationary thrust bearing face the rotating thrust bearing, said thrust bearings being separated, in operation, by a lubricating film. According to the invention, said stationary thrust bearing comprises at least two sets of pads and is as defined above. Said rotating thrust bearing is in the form of a flange provided with a through-opening which receives the shaft, and has a diameter at least of the order of that covered both by the first and second sets of pads.

In particular according to the invention, the thrust bearing system is equipped to receive a lubricant, and the first set of pads provides the usual hydraulic support between said stationary thrust bearing and said rotating thrust bearing. The second set of pads provides the hydraulic support between said stationary thrust bearing and said rotating thrust bearing, in the event of the surface of the pads of the first set becoming degraded.

The invention also provides a turbocharger in a device for forced induction of gaseous oxidant, in general air, of an internal combustion engine, comprising a rotation shaft mounted between a turbine wheel that is driven by the energy of the exhaust gases of the engine, and a compressor wheel for the intake oxidant (air), said shaft being mounted in rotation in a guide bearing equipped with a stationary and rotating thrust bearing system able to withstand an axial load along the axis of the shaft, said thrust bearing system comprising a stationary thrust bearing having at least two sets of pads and is as described above.

The invention also relates to a motor vehicle having an engine comprising a turbocharger as described above.

In the description of the invention, it is considered that the stationary thrust bearing comprises at least one first and one second set of pads, which does not exclude a third set of pads. It is indeed possible to provide, in general terms, a plurality of sets which would be axially offset by several microns one after the other, but it is preferable to limit the number of sets of pads so as to not have to provide a large rotating thrust bearing, which would imply a greater risk of friction. Therefore, the preferred form is a stationary thrust bearing comprising only two offset sets of pads.

Other particulars and advantages of the invention will emerge upon reading the following description of a particular embodiment of the invention, provided by way of indication but not by way of limitation, with reference to the appended drawings, in which:

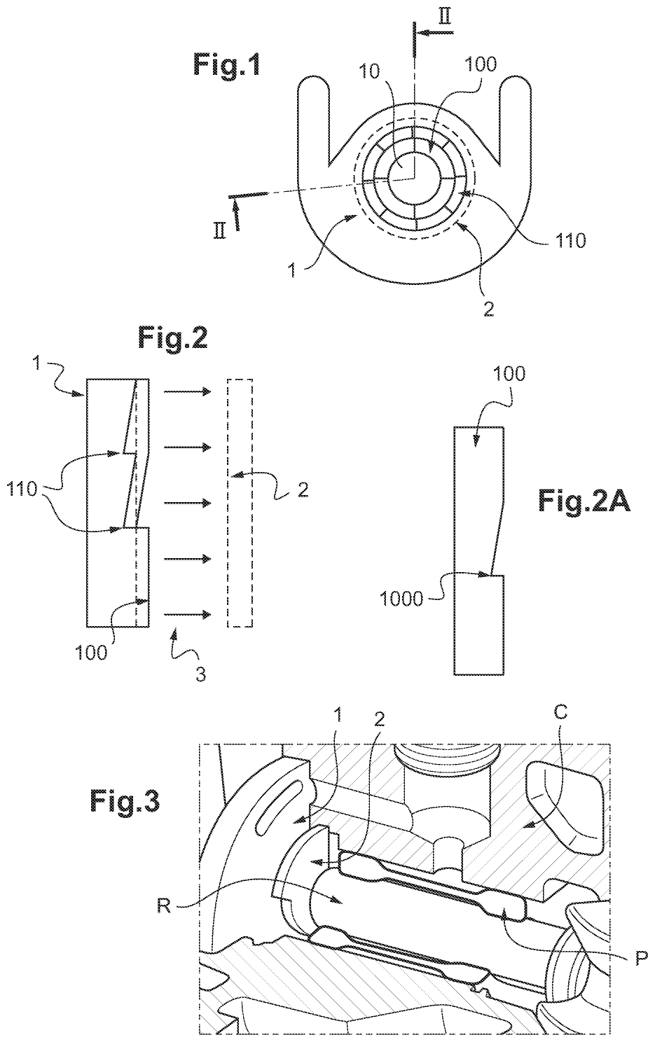

FIG. 1 illustrates, schematically and in a front view, a thrust bearing system comprising a stationary thrust bearing having two sets of pads, according to the invention;

FIG. 2 illustrates, schematically and in a view in radial section II-II, the thrust bearings of the thrust bearing system shown diagrammatically in FIG. 1, FIG. 2A illustrating in section a pad of one set;

FIG. 3 illustrates, schematically and in a partial perspective cutaway view, the arrangement of the part relating to the rotation shaft of a turbocharger guided in a bearing with a thrust bearing system, mounted in a casing.

FIG. 1 illustrates, by means of a schematic front view, a thrust bearing system comprising a stationary thrust bearing 1 in the form of a flange having the shape of a generally circular plate, in which is created a central through-opening 10 designed to allow a rotation shaft to pass through. The thrust bearing system also comprises a rotating thrust bearing 2 that takes the form of a flange, in particular a washer, the circular outline of which is indicated by dashed lines in FIG. 1.

According to the invention, the face of the flange of the stationary thrust bearing has a first set of pads 100 arranged in a ring following the perimeter of the central opening 10, and a second set of pads 110 arranged in a ring around the first set of pads, following the larger diameter of the ring of the first set of pads.

FIG. 2 schematically illustrates a partial view in section in the region of the pads of FIG. 1, the elements not being drawn to scale for the sake of the clarity of the drawing. The stationary thrust bearing with pads 1 is arranged facing the rotating thrust bearing 2. The pads of the second set 110 are arranged set back, by several micrometers in the longitudinal direction of the axis of said opening, from the first set of pads 100 in the longitudinal direction X of the axis of said opening. Thus, the most prominent point of the surface of the first set of pads exceeds the most prominent point of the surface of the second set of pads, for example by approximately 2 to 3 μm.

The pads of the first and of the second set have regions that are structured by shoulders, as illustrated in FIG. 2A for a pad of the first set, creating a relief at the surface of the pads, the troughs 1000 of which constitute micro-reservoirs for the lubricant used in the thrust bearing system. The stationary and rotating thrust bearings are arranged such that the structured regions of the pads face the rotating thrust bearing so as to create, in operation, a lubricant film 3 between this stationary thrust bearing and the rotating thrust bearing, avoiding mechanical contact between the two thrust bearings.

The lubricant may be an oil which is conveyed from a reservoir to the device comprising the thrust bearing system, with the oil being conveyed up to the thrust bearing system.

The hydraulic support surface, also referred to as the supporting surface, of each set of pads is defined by the surface of the structured regions of the respective pads of the set in question. Determining the surface of the structured regions is known per se, it is based on considering the height of the profile of the reliefs and the width of the reliefs.

In general, the thrust bearings are metal parts. The stationary thrust bearing having pads is created by (impact) stamping from a metal plate, creating structured embossings which form the set of pads. The two sets of pads are advantageously created simultaneously during stamping of the plate.

FIG. 3 illustrates an arrangement of the part relating to a rotation shaft R of a turbocharger mounted in rotation in a guide bearing P and with a thrust bearing system, mounted in a casing C. The rotating thrust bearing 2 is mounted around the shaft R and conjointly with said shaft which drives it in rotation therewith. The stationary thrust bearing 1 is mounted coaxially with the rotating thrust bearing but is not conjoined with the rotation shaft, so as to be held stationary. The turbocharger is advantageously that of the system for forced induction of air of an internal combustion engine, the operation of which was briefly touched upon in the introduction of the description.

According to the invention, the rotating thrust bearing of the thrust bearing system is in the form of a flange, which can be reduced to a simple washer, provided with a through-opening that receives the shaft. The overall diameter of its flange must be at least of the order of that covered both by the first and second sets of pads.

Owing to the fact that the surface of the second set of pads is set back from the surface of the first set of pads, it is then this first set of pads which normally provides the hydraulic support with the rotating thrust bearing. In the event of wear of the first set of pads, for example due to ingress of dirt causing disruption of the film of oil and/or wear of the pads of the first set, the support will then shift to the second set of pads.

Preferably, according to the invention, the first set of pads is of the “conventional” type, it provides, under normal usage conditions, the hydraulic support between the stationary thrust bearing and the rotating thrust bearing. The first set of pads is preferably dimensioned within the closest possible limits in order to have the smallest possible supporting surface and to have the least possible sliding friction.

The second set of pads may have a supporting surface essentially identical to the first if one wishes to favour the maintaining of friction performance, to the extent that the first set of pads is dimensioned to that end.

This second set of pads may have a supporting surface strictly greater than the first if one wishes to promote the reliability of the system in the event of abnormal operation (ingress of dirt into the lubricant, for example).

The invention has achieved its objectives by proposing a thrust bearing system whose stationary thrust bearing having pads serves to provide the robustness of the system with respect to maintaining the lubricant film between the thrust bearings under all circumstances. The stationary thrust bearing is of simple design, the rotating thrust bearing is easily matched to the system. The invention relates more specifically to the field of vehicles having an internal combustion engine, in particular those using diesel or gasoline as fuel.

1-10. (canceled)

11. A stationary thrust bearing of a stationary and rotating thrust bearing system designed to withstand an axial load along an axis of a rotation shaft mounted in a guide bearing, said stationary thrust bearing comprising:
a flange in which is created a through-opening that allows the rotation shaft to pass through; and
at least two sets of pads with structured regions, including a first set of pads with structured regions present in a first ring on a face of said flange, and a second set of pads with structured regions present in a second ring, coaxial with the first ring, on said face of the flange, set back relative to said first set of pads in a longitudinal direction of the axis of said opening.

12. The thrust bearing as claimed in claim 11, wherein said second set of pads is set back from said first set of pads by a distance of several micrometers in the longitudinal direction of the axis of said opening.

13. The thrust bearing as claimed in claim 11, wherein the pads of the first set are arranged in a ring following a perimeter of the opening of the flange and the pads of the second set of pads are arranged in a ring following a perimeter of a larger circumference of the first ring formed by said first set of pads.

14. The thrust bearing as claimed in claim 11, wherein the second set of pads has a hydraulic support surface, defined by the structured regions of its pads, which is essentially identical to or strictly greater than that of the first set of pads.

15. The thrust bearing as claimed in claim 11, wherein the guide bearing is a guide bearing of a turbocharger.

16. A thrust bearing system to be mounted about a rotation shaft of a turbocharger mounted in a guide bearing to withstand an axial load along an axis of the shaft, said system comprising:
a rotating thrust bearing mounted conjointly around said shaft; and
a stationary thrust bearing which has pads with structured regions and through which said shaft can pass,
said thrust bearings being arranged face-to-face in the longitudinal direction of their axis, corresponding to the axis of the shaft, and such that the structured regions of said pads of the stationary thrust bearing face the rotating thrust bearing,
said thrust bearings being separated, in operation, by a lubricating film,
wherein stationary thrust bearing is the thrust bearing as claimed in claim 11, and
wherein said rotating thrust bearing is a flange provided with a through-opening which receives the shaft, and has a diameter of the order of that covered both by the first and second sets of pads.

17. The thrust bearing system as claimed in claim 16, wherein said second set of pads is set back from said first set of pads by a distance of several micrometers in the longitudinal direction of the axis of said opening.

18. The thrust bearing system as claimed in claim 16, wherein the pads of the first set are arranged in a ring following a perimeter of the opening of the flange and the pads of the second set of pads are arranged in a ring following a perimeter of a larger circumference of the first ring formed by said first set of pads.

19. The thrust bearing system as claimed in claim 16, wherein the second set of pads has a hydraulic support surface, defined by the structured regions of its pads, which is essentially identical to or strictly greater than that of the first set of pads.

20. The thrust bearing system as claimed in claim 16, being configured to receive a lubricant, wherein the first set of pads provides the hydraulic support between said stationary thrust bearing and said rotating thrust bearing.

21. The thrust bearing system as claimed in claim 20, wherein the second set of pads provides the hydraulic support between said stationary thrust bearing and said rotating thrust bearing, in the event of the surface of the pads of the first set becoming degraded.

22. A turbocharger in a device for forced induction of gaseous oxidant of an internal combustion engine, comprising:
a rotation shaft mounted between a turbine wheel that is driven by the energy of the exhaust gases of the engine; and
a compressor wheel for the intake oxidant,
said shaft being mounted in rotation in a guide bearing equipped with a thrust bearing system able to withstand an axial load along the axis of the shaft,
wherein the thrust bearing system is the thrust bearing system as claimed in claim 16.

23. The turbocharger as defined in claim 22, wherein the gaseous oxidant is air.

24. A motor vehicle, comprising:
an internal combustion engine comprising the turbocharger as defined in claim 22.
